(19) United States
(12) Patent Application Publication
(10) Pub. No.: US 2011/0169791 A1
(43) Pub. Date: Jul. 14, 2011

(54) DISPLAY DEVICE

(75) Inventors: Yasuhiro Hida, Osaka-shi (JP); Gen Nagaoka, Osaka-shi (JP); Ichiro Umekawa, Osaka-shi (JP); Motoji Shiota, Osaka-shi (JP); Yukio Shimizu, Osaka-shi (JP)

(73) Assignee: SHARP KABUSHIKI KAISHA, Osaka-shi, Osaka (JP)

(21) Appl. No.: 13/119,966

(22) PCT Filed: Jun. 19, 2009
(86) PCT No.: PCT/JP2009/061200

§ 371 Date: Mar. 21, 2011

(30) Foreign Application Priority Data
Sep. 29, 2008 (JP) 2008-250224

(51) Int. Cl. G06F 3/038; G09G 3/36

(52) U.S. Cl. 345/204; 345/87

(57) ABSTRACT

In a liquid crystal display device (10), stabilizing capacitors (61), bypass capacitors (62) and boosting capacitors (63), which would conventionally be mounted on an FPC board (50), are disposed along long and short input sides of an LSI chip (40) mounted on a projection (20a) of a glass substrate (20) and the capacitors are connected to their respective input terminals of the LSI chip (40) via capacitor traces (71). This makes it possible to narrow the FPC board (50) connected to the liquid crystal display device (10), thereby achieving size reduction of the liquid crystal display device (10) while achieving reduction in manufacturing cost, including processing and material cost of the FPC board (50).

### TECHNICAL FIELD

The present invention relates to display devices, more specifically to a display device including a circuit board via which external video signals, clock signals, and so on, are provided.

### BACKGROUND ART

FIG. 8 is a schematic plan view of a conventional liquid crystal display device 310 provided in a cell phone or suchlike. As shown in FIG. 8, the liquid crystal display device 310 includes a pair of opposingly arranged glass substrates 320 and 325, an LSI chip 340, an FPC board 350, and a plurality of discrete electronic components 360 such as capacitors. Hereinafter, the liquid crystal display device includes a pair of opposingly disposed glass substrates, an LSI chip mounted on one of the glass substrates, an FPC board, and discrete electronic components such as capacitors, but does not include any backlights and polarizers.

In a space between the pair of glass substrates 320 and 325, a liquid crystal (not shown) is sealed by a seal material (not shown), and a display portion 330 is formed on the glass substrate 325. Also, the glass substrate 320 includes a projection 320a having mounted thereon a large-scale integration (hereinafter, “LSI”) chip 340, which has a driver function required for driving the liquid crystal, and a flexible printed circuit (hereinafter, “FPC”) board 350 connected to an electronic device main board 390. When the main board 390 provides a video signal to the LSI chip 340 via the FPC board 350, the LSI chip 340 displays video on the display portion 330.

In order to drive the display portion 330, the LSI chip 340 requires a number of output terminals in accordance with the number of pixels and therefore is formed in an elongated shape with the long side parallel to the display portion 330. Accordingly, the FPC board 350, which provides video signals, clock signals and so on from the main board 390 to the LSI chip 340, has a width approximately the same length as the long side of the LSI chip 340.

Also, video signals, clock signals, and so on, are provided from the main board 390 to corresponding input terminals of the LSI chip 340 via such a wide FPC board 350, and therefore the projection 320a has little available space. Accordingly, the discrete electronic components 360, such as boosting capacitors and stabilizing capacitors, required for the operation of the LSI chip 340, are solder-mounted on the FPC board 350 having available space.

For further size reduction of electronic devices, such as cell phones, which have such a liquid crystal display device 310 provided therein, one option under study is narrowing of the gap between printed circuit boards having electronic components mounted thereon, in addition to size reduction of the electronic components to be mounted.

Conventionally, to narrow the gap between the printed circuit boards, the FPC board 350 connected to the projection 320a of the glass substrate 320 is bent to reduce the apparent width of the FPC board 350, and the printed circuit boards are stored in available space secured around the FPC board 350. FIG. 9 provides views (A to C) illustrating the procedure of bending the FPC board 350 connected to the projection 320a of the glass substrate 320. First, as shown in FIG. 9(A), the FPC board 350, which has a width approximately the same length as the long side of the LSI chip 340, is connected to the projection 320a by thermocompression bonding using an anisotropic conductive film (hereinafter, “ACF”; not shown). The FPC board 350 is then bent along the upper edge of the glass substrate 320 in a direction from the front to the back of the figure. Next, as shown in FIG. 9(B), portions of the FPC board 350 that stick out from either the right or left side of the glass substrate 320 are bent along the right or left edge of the glass substrate 320 in a direction from the back to the front of the figure. Subsequently, as shown in FIG. 9(C), the bent portions are fixed to the glass substrate 320 with tape (not shown). In this manner, the wide FPC board 350 is bent to narrow the actual width W of the FPC board 350, thereby securing space available for storing other printed circuit boards around the FPC board 350.

Also, Patent Document 1 discloses a liquid crystal display device in which smoothing capacitors to be used with a power circuit included in an LSI chip are connected to the power circuit via trace formed on a glass substrate.

### CITATION LIST

### Patent Document

[Patent Document 1] Japanese Laid-Open Patent Publication No. 7-261191

### DISCLOSURE OF THE INVENTION

### Problems to be Solved by the Invention

However, in the case where the FPC board 350 with a width approximately the same length as the long side of the LSI chip 340 is bent and folded on the glass substrate 320, and then the folded FPC board 350 is attached to the glass substrate 320 with tape, the processes of bending and fixing the FPC board 350 with tape are required, resulting in increased packaging cost. Also, using the FPC board 350 with a width approximately the same length as the long side of the LSI chip 340 results in increased cost of material and processing of the FPC board 350. Furthermore, the FPC board 350 has long trace layers connected to the discrete electronic components 360, and therefore the LSI chip 340 is affected by electro magnetic interference (hereinafter, “EMI”) and is prone to operate in an unstable manner.

Also, as for the liquid crystal display device disclosed in Patent Document 1, the length of trace for connecting the smoothing capacitors to the LSI chip is not taken into consideration at all. As a result, the longer the trace becomes, the greater the trace resistance becomes, resulting in voltage drop, so that the power circuit cannot operate normally.

Therefore, an objective of the present invention is to provide a display device capable of operating stably while achieving reduction in size and manufacturing cost, including packaging and material cost of an FPC board.

### Means for Solving the Problems

A first aspect of the present invention is directed to a display device for displaying video based on an externally provided video signal, comprising:

a first insulating substrate;

a display portion formed on the first insulating substrate to display video;

a driver circuit disposed on the first insulating substrate to drive the display portion based on the video signal;

discrete electronic components disposed on the first insulating substrate and required for operating the driver circuit;

component traces formed on the first insulating substrate to connect the driver circuit and the discrete electronic components; and

a circuit board having trace layers for providing externally provided signals and reference potential to the driver circuit and firmly attached to the first insulating substrate with the trace layers being connected to input traces formed on the first insulating substrate,

the discrete electronic components are disposed adjacent to the driver circuit and connected by the component traces to terminals of the driver circuit that correspond to the discrete electronic components.

In a second aspect of the present invention, based on the first aspect of the invention, the discrete electronic components are connected to the component traces by anisotropic conductive adhesives.

In a third aspect of the present invention, based on the first aspect of the invention, the first insulating substrate has a projection, the driver circuit is a first driver circuit formed on the projection, including driver circuit to drive the display portion and a power generation circuit for providing a required voltage to the display portion, and the discrete electronic components are disposed on the projection so as to be at least adjacent to the long side of the first driver circuit and connected to the first driver circuit by the component traces.

In a fourth aspect of the present invention, based on the third aspect of the invention, the first driver circuit is a first integrated circuit chip having bump electrodes formed on its surface, and the discrete electronic components are connected to the first integrated circuit chip by anisotropic conductive adhesives provided between the component traces and the bump electrodes.

In a fifth aspect of the present invention, based on the first aspect of the invention, further comprised is a second insulating substrate disposed so as to be opposed to the first insulating substrate at a predetermined distance,

the first insulating substrate has a projection,

the driver circuit includes a second driver circuit including driver circuit for driving the display portion and a thin-film power generation circuit for providing a required voltage to the display portion, the second driver circuit being disposed on the first insulating substrate, the thin-film power generation circuit being formed together with the display portion on the first insulating substrate opposed to the second insulating substrate,

the discrete electronic components include first discrete electronic components required for operating the second driver circuit and second discrete electronic components required for operating the thin-film power generation circuit,

the component traces include first component traces connecting the second driver circuit to the first discrete electronic components and second component traces connecting the thin-film power generation circuit to the second discrete electronic components,

the first discrete electronic components are disposed on the projection so as to be at least adjacent to the long side of the second driver circuit and connected by the first component traces to the second driver circuit, and

the second discrete electronic components are disposed on the projection adjacent to an edge of the second insulating substrate and connected by the second component traces to the thin-film power generation circuit.

In a sixth aspect of the present invention, based on the fifth aspect of the invention, the second driver circuit is a second integrated circuit chip having bump electrodes formed on its surface, and the first discrete electronic components are connected to the second integrated circuit chip by anisotropic conductive adhesives provided between the first component traces and the bump electrodes.

In a seventh aspect of the present invention, based on the first aspect of the invention, further comprised is a second insulating substrate disposed so as to be opposed to the first insulating substrate at a predetermined distance,

the first insulating substrate has a projection,

the driver circuit includes a thin-film driver circuit for driving the display portion and a thin-film power generation circuit for providing a required voltage to the display portion, the thin-film driver circuit and the thin-film power generation circuit being formed together with the display portion on the first insulating substrate opposed to the second insulating substrate,

the discrete electronic components include first discrete electronic components required for operating the thin-film driver circuit and second discrete electronic components required for operating the thin-film power generation circuit,

the component traces include first component traces connecting the second driver circuit to the first discrete electronic components and second component traces connecting the thin-film power generation circuit to the second discrete electronic components,

the first discrete electronic components are disposed on the projection adjacent to an edge of the second insulating substrate and connected by the first component traces to the thin-film driver circuit, and

the second discrete electronic components are disposed on the projection adjacent to the edge of the second insulating substrate and connected by the second component traces to the thin-film power generation circuit.

In a eighth aspect of the present invention, based on the first aspect of the invention, the discrete electronic components are disposed close to the driver circuit such that trace resistance of the component traces has a resistance value not affecting the operation of the driver circuit.

In a ninth aspect of the present invention, based on the eighth aspect of the invention, the component traces are made of the same material as traces within the display portion.

In a tenth aspect of the present invention, based on the first aspect of the invention, the discrete electronic components at least include chip capacitors, chip resistors, chip coils, light-emitting diodes or other diodes.

In a eleventh aspect of the present invention, based on the tenth aspect of the invention, further comprised is a grounding conductor formed on the first insulating substrate to provide reference potential,

the chip capacitors include:
boosting capacitors for generating voltage to be provided at a predetermined value to the display portion in concert with the driver circuit, the boosting capacitors having terminals connected to corresponding terminals of the driver circuit;
stabilizing capacitors for removing noise superimposed on voltage generated within the driver circuit, the stabilizing capacitors each being connected at one terminal to a corresponding terminal of the driver circuit and at the other to the grounding conductor; and
bypass capacitors for removing noise superimposed on signals externally provided via the trace layers of the circuit board, the bypass capacitors each being connected at one terminal to a corresponding terminal of the driver circuit and at the other to the grounding conductor.

In a twelfth aspect of the present invention, based on the first aspect of the invention, the circuit board is a flexible circuit board, and the trace layers of the flexible circuit board are connected to the input traces formed on the first insulating substrate by anisotropic conductive adhesives.

In a thirteenth aspect of the present invention, based on the first aspect of the invention, further comprised is a connector connected to the input traces formed on the first insulating substrate by an anisotropic conductive adhesive, the circuit board is a stiff, rigid circuit board, and the trace layers formed on the rigid circuit board are connected to the input traces by the connector.

In a fourteenth aspect of the present invention, based on the first aspect of the invention, the driver circuit has provided thereto a series of input terminals corresponding to the trace layers formed on the circuit board.

In a fifteenth aspect of the present invention, based on the first aspect of the invention, further comprised is a liquid crystal enclosed in the display portion, the driver circuit drives the liquid crystal based on the video signal externally provided via the circuit board, thereby displaying video on the display portion.

### EFFECT OF THE INVENTION

According to the first aspect of the present invention, when the discrete electronic components required for the operation of the driver circuit are connected to the driver circuit via the component traces formed on the first insulating substrate, the discrete electronic components are disposed adjacent to terminals of the driver circuit that correspond to the discrete electronic components, and therefore the resistance value of the component traces can be kept low. Consequently, any voltage drop due to a high resistance value of the component traces and any delay in the rise and fall of signals can be prevented, allowing the driver circuit to operate normally. Also, the discrete electronic components are mounted on the first insulating substrate, rather than on the circuit board, and therefore the circuit board can be narrowed. Consequently, available space can be secured around the circuit board, making it possible to achieve size reduction of an electronic device having the display device provided therein, thereby achieving cost reduction, such as reduction in cost of material and processing of the circuit board. The use of a narrower circuit board results in reduced cost for packaging the circuit board in the display device. Also, the component traces can be shortened, and therefore it is possible to prevent unstable operation of the driver circuit due to EMI.

According to the second aspect of the present invention, the discrete electronic components can be connected to the component traces via the anisotropic conductive adhesives, and therefore it is possible to increase mounting density of the discrete electronic components.

According to the third aspect of the present invention, the discrete electronic components are disposed at least adjacent to the long side of the first driver circuit and connected to the first driver circuit. Thus, the display device can achieve the same effect as in the first aspect.

According to the fourth aspect of the present invention, the driver circuit is a first integrated circuit chip having bump electrodes formed on its surface, and the discrete electronic components are connected to the bump electrodes of the first integrated circuit chip bonded face-down. Thus, by reducing the mounting area of the first integrated circuit chip, the first insulating substrate can be reduced in size.

According to the fifth aspect of the present invention, the driver circuit includes the second driver circuit including driver circuit and the thin-film power generation circuit. The first discrete electronic components connected to the second driver circuit are disposed at least adjacent to the long side of the second driver circuit and connected to the second driver circuit via the first component traces. Also, the second discrete electronic components connected to the thin-film power generation circuit are disposed on the projection adjacent to the edge of the second insulating substrate and connected to the thin-film power generation circuit via the second component traces. Thus, the display device can achieve the same effect as in the first aspect.

According to the sixth aspect of the present invention, the second driver circuit is a second integrated circuit chip having bump electrodes formed on its surface, and the discrete electronic components are connected to the bump electrodes of the second integrated circuit chip bonded face-down. Thus, by reducing the mounting area of the second integrated circuit chip, the first insulating substrate can be reduced in size.

According to the seventh aspect of the present invention, the driver circuit includes the thin-film driver circuit and the thin-film power generation circuit, which are formed together with the display portion. The first discrete electronic components connected to the thin-film driver circuit and the second discrete electronic components connected to the thin-film power generation circuit are disposed on the projection adjacent to the edge of the second insulating substrate and respectively connected to the thin-film driver circuit and the thin-film power circuit by the first and second component traces. Thus, the display device can achieve the same effect as in the first aspect.

According to the eighth aspect of the present invention, the discrete electronic components are disposed close to the driver circuit such that the trace resistance of the component traces has a resistance value not affecting the operation of the driver circuit. In this case, there is neither any delay in the rise and fall of signals provided to the driver circuit nor any drop in voltage. Thus, the driver circuit can operate normally.

According to the ninth aspect of the present invention, the component traces connecting the driver circuit and the discrete electronic components can be made of the same material as the traces within the display portion, and therefore the component traces can be simultaneously formed with the traces within the display portion. Thus, the process of manufacturing the display device can be simplified.

According to the tenth aspect of the present invention, at least the chip capacitors, the chip resistors, the chip coils, the light-emitting diodes or other diodes are formed on the first insulating substrate, and therefore the circuit board can be narrowed correspondingly.

According to the eleventh aspect of the present invention, the first insulating substrate has sufficient space to form the grounding conductor, and therefore the grounding conductor can be widened to reduce its wiring resistance. Also, the stabilizing capacitors and the bypass capacitors are each connected at one terminal to the grounding conductor, and therefore noise superimposed on signals and voltage can be transferred to the grounding conductor, thereby preventing malfunction of the driver circuit due to noise. The boosting capacitors can generate voltage required for driving the display portion in concert with the power generation circuit.

According to the twelfth aspect of the present invention, the circuit board is a flexible circuit board, and therefore the display device can be packaged in an electronic device by bending the circuit board. Thus, the electronic device can be reduced in size.

According to the thirteenth aspect of the present invention, the circuit board is a rigid circuit board connected to the input traces formed on the first insulating substrate by the connector. Thus, the rigid circuit board can be attached to/removed from the connector as many times as needed.

According to the fourteenth aspect of the present invention, the input terminals of the driver circuit are a series of terminals formed corresponding to the input traces on the circuit board without any intervening terminals connected to the discrete electronic components, and therefore the circuit board can be narrowed.

According to the fifteenth aspect of the present invention, it is possible to drive the liquid crystal enclosed in the display portion based on an externally provided video signal, thereby displaying video on the display portion.

### BRIEF DESCRIPTION OF THE DRAWINGS

FIG. 1 is a schematic plan view of a liquid crystal display device including an FPC board with capacitors mounted thereon.

FIG. 2 is a schematic plan view of a liquid crystal display device 410 including a narrow FPC board 450.

FIG. 3 is a schematic plan view illustrating the configuration of a liquid crystal display device according to a first embodiment of the present invention.

FIG. 4 provides (A) a perspective view of the liquid crystal display device shown in FIG. 3, (B) a cross-sectional view of the liquid crystal display device taken along line A-A indicated by arrows in (A), and (C) a cross-sectional view of the liquid crystal display device taken along line B-B indicated by arrows in (A).

FIG. 5 is a schematic plan view illustrating the configuration of a liquid crystal display device according to a second embodiment of the present invention.

FIG. 6 is a schematic plan view illustrating the configuration of a liquid crystal display device according to a third embodiment of the present invention.

FIG. 7 provides (A) a perspective view of a liquid crystal display device having a rigid circuit board attached thereto and (B) a cross-sectional view of the liquid crystal display device taken along line C-C indicated by arrows in (A).

FIG. 8 is a schematic plan view of a conventional liquid crystal display device.

FIG. 9 provides views (A to C) illustrating the procedure of bending an FPC board connected to a projection of a glass substrate.

### BEST MODE FOR CARRYING OUT THE INVENTION

<1. Basic Study>

FIG. 1 is a schematic plan view of a liquid crystal display device 310 including an FPC board 350 with capacitors 363 mounted thereon. As shown in FIG. 1, the FPC board 350 has formed thereon a trace layer 371 for connecting the capacitors 363 and a trace layer 374 for providing external video signals, external clock signals, and so on, to an LSI chip 340. Accordingly, the FPC board 350 has a wide width approximately the same length as the long side of the LSI chip 340.

Among the trace layers of the FPC board 350, the need for the trace layer 371 connected to the capacitors 363 is eliminated by removing the capacitors 363 mounted on the FPC board 350. Therefore, by omitting the unnecessary trace layer 371 from the FPC board 350, the FPC board 350 can be narrowed. By connecting the narrowed FPC board 350 without the trace layer 371 to a projection 320a, some space is made available on the projection 320a. Therefore, the capacitors 363 removed from the FPC board 350 can be mounted in that available space.

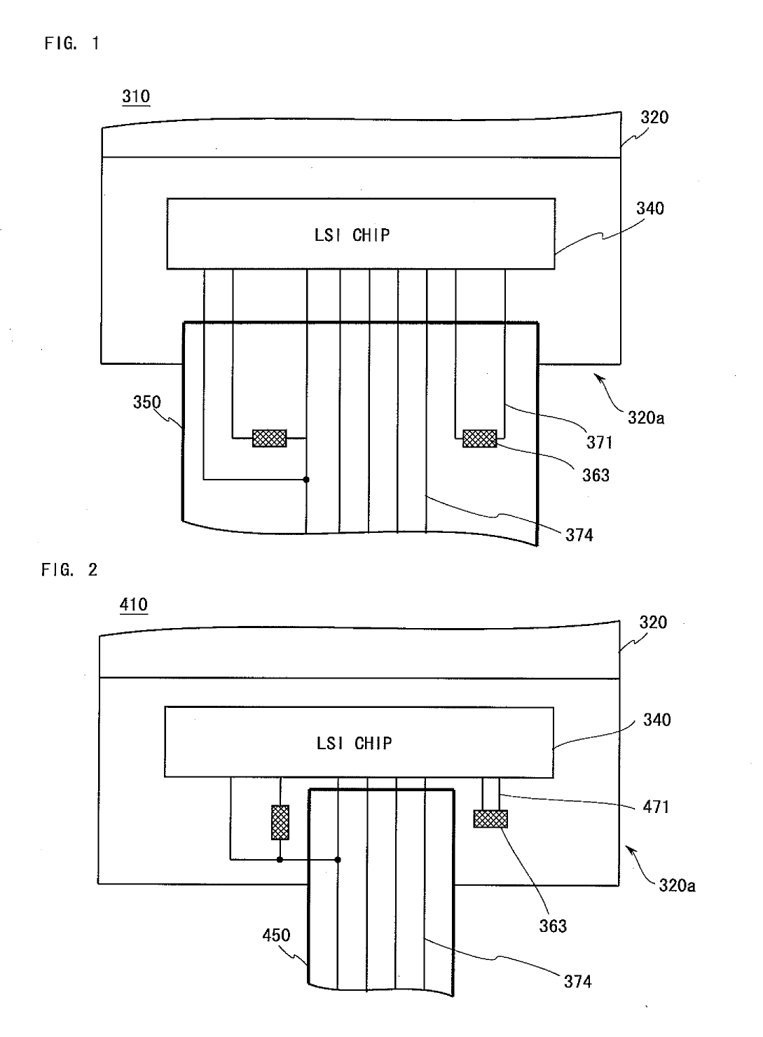

FIG. 2 is a schematic plan view of a liquid crystal display device 410 including a narrow FPC board 450. Elements of the liquid crystal display device 410 shown in FIG. 2 that are the same as or correspond to those of the liquid crystal display device 310 shown in FIG. 1 are denoted by the same reference characters, and descriptions will be given mainly focusing on differences from the liquid crystal display device 310.

As shown in FIG. 2, the capacitors 363 are connected to their corresponding terminals of the LSI chip 340 via traces 471 formed on the glass substrate 320. However, in the case where the capacitors 363 are mounted away from the LSI chip 340, the traces 471 are lengthened, resulting in increased trace resistance. In this manner, when the trace resistance of the traces 471 is increased, voltage drop occurs, leading to a possibility that the LSI chip 340 might fail to operate normally.

So, a study will be conducted regarding the resistance value of the traces 471 formed on the projection 320a of the liquid crystal display device 410 in comparison with the resistance value of the trace layer 374 on the FPC board 450. The trace layer 374 on the FPC board 450 is formed of copper foil (Cu) having a thickness of 8 μm or more. Copper has a specific resistance of 1.55×10⁻⁸ Ωm at 0° C., and therefore the sheet resistance thereof takes a sufficiently low value of 0.002 Ω/ or less.

However, copper is difficult to process by etching, and therefore is not used in the process of manufacturing the liquid crystal display device 410. So, a case will be described where the traces 471 are formed using tantalum (Ta) or aluminum (Al) as used in the process of manufacturing the liquid crystal display device 410. The sheet resistance is obtained for tantalum and aluminum of 0.2 to 0.4 μm in thickness. The specific resistance of tantalum is 12.3×10⁻⁸ Ωm at 0° C., and therefore the sheet resistance thereof is 0.3 to 0.6 Ω/. Also, aluminum has a specific resistance of 2.5×10⁻⁸ Ωm at 0° C., and therefore the sheet resistance thereof is 0.06 to 0.12 Ω/. In this manner, tantalum and aluminum have the sheet resistances tens to hundreds times higher than the sheet resistance of copper.

Next, copper, tantalum and aluminum traces will be compared in terms of length assuming that they are equal in resistance value. When the traces are 50 μm in width and their allowable resistance value is 50Ω, a copper trace of 8 μm in thickness has an allowable length of up to 1250 mm. On the other hand, the tantalum and aluminum traces of 0.2 to 0.4 μm in thickness have their allowable lengths of 5 to 25 mm, which are understandably much shorter than the copper trace.

In recent years, as the pitch between bump electrodes as formed on the LSI chip 340 becomes finer, the traces as formed on the projection 320a become narrower in the range from 20 to 30 μm, so that the allowable resistance value is further reduced to 10 to 30Ω. Accordingly, to reduce the trace resistance, the traces are required to be shortened even if by only 1 mm.

In this manner, to mount the capacitors 363, which are conventionally solder-mounted on the FPC board 350, onto the projection 320a, it is understandably necessary to determine the positions of the capacitors 363 on the projection 320a, considering the length of the tantalum or aluminum traces 471 for connecting the capacitors 363 to their corresponding terminals of the LSI chip 340.

<2. First Embodiment>

<2.1 Configuration Of The Liquid Crystal Display Device>

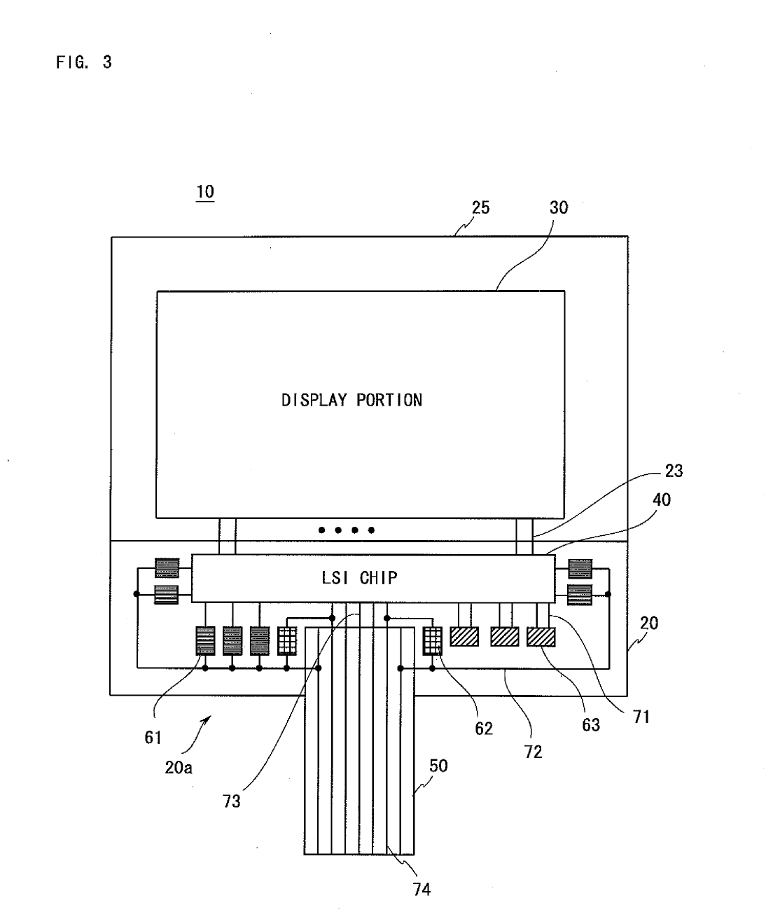

FIG. 3 is a schematic plan view illustrating the configuration of a liquid crystal display device 10 according to a first embodiment of the present invention. The liquid crystal display device 10 includes a pair of opposingly disposed glass substrates 20 and 25, an LSI chip 40, an FPC board 50, seven stabilizing capacitors 61, two bypass capacitors 62, and three boosting capacitors 63, as shown in FIG. 3.

A liquid crystal (not shown) is enclosed in a space between the pair of glass substrates 20 and 25 using a seal material (not shown), and a display portion 30 is formed on the glass substrate 25. The glass substrate 20 includes a projection 20a, which has mounted thereon the LSI chip 40 having a driver function required for driving the liquid crystal and the FPC board 50 connected to an external main board or suchlike. When a video signal is externally provided to the LSI chip 40 via the FPC board 50, the LSI chip 40 displays video on the display portion 30.

The LSI chip 40 is a bare chip (an unpackaged chip) having circuit patterns, including a gate driver, a source driver and a DC/DC converter, formed on the surface of a silicon substrate using microfabrication technology and also having formed thereon about 15 μm-high bump electrodes which function as connecting terminals for connecting the circuit patterns to the exterior. Note that both the gate driver and the source driver may be referred to herein as driver circuits and the DC/DC converter as a power generation circuit.

The FPC board 50 is a freely bendable board having a plurality of 8 to 50 μm-thick copper foil trace layers 74 formed on one side of a 12 to 50 μm-thick flexible insulating film 51. Note that the trace layers 74 may be formed on both sides of the insulating film 51, rather than only on one side.

The stabilizing capacitors 61 are capacitors used for removing voltage-superimposed noise generated by the LSI chip 40, thereby preventing malfunction of the LSI chip 40 due to noise, and each of the capacitors is connected at one terminal to a terminal of the LSI chip 40 and at the other terminal to a grounding conductor 72 formed on the projection 20a.

The bypass capacitors 62 are capacitors used for removing noise superimposed on, for example, video signals, clock signals and reference voltage externally provided via the FPC board 50, thereby preventing malfunction of the LSI chip 40 due to noise, and each of the capacitors are connected at one terminal to an FPC trace 73, which connects the trace layer 74 to the LSI chip 40, and at the other terminal to the grounding conductor 72.

The boosting capacitors 63 are capacitors used for boosting voltage in concert with a booster circuit (a charge pump circuit) included in the LSI chip 40, and each of the capacitors are connected at both terminals to their respective terminals of the LSI chip 40.

For example, in the case of a 2-inch QVGA (Quarter Video Graphics Array) liquid crystal display device, the stabilizing capacitors 61, the bypass capacitors 62 and the boosting capacitors 63 are ceramic chip capacitors with capacity 1 to 2.2 μF, withstand voltage 6.3 to 16V, and 1.0 mm×0.5 mm in size, and a total of 10 to 20 such capacitors are mounted on the projection 20a.

Also, the grounding conductor 72 connected to the other ends of the stabilizing capacitors 61 and the bypass capacitors 62 is formed of a tantalum or aluminum thin film. The projection 20a has sufficient space to form the grounding conductor 72, and therefore can have its width increased unless its wiring resistance causes any problem. Also, when an ACF is used to connect the FPC board 50 to the projection 20a as will be described later, the grounding conductor 72 is simultaneously connected via the ACF to any of the trace layers 74 on the FPC board 50 that provide ground potential, and therefore the potential of the grounding conductor 72 is fixed at the ground potential.

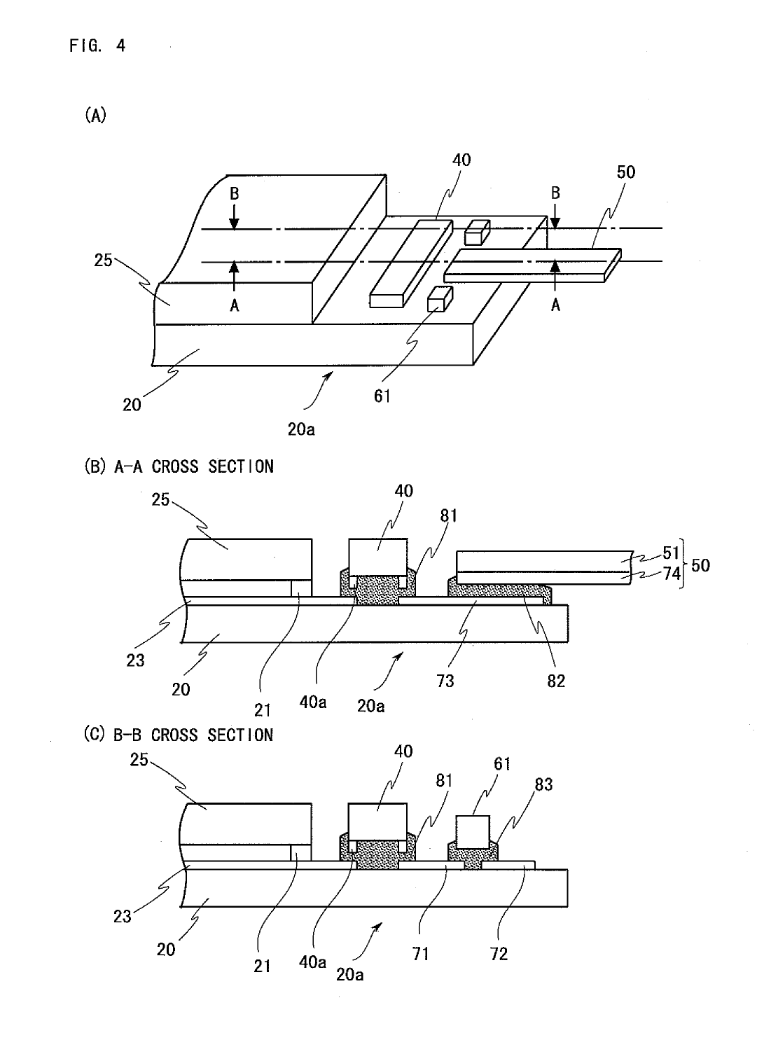

FIG. 4 provides (A) a perspective view of the liquid crystal display device 10 shown in FIG. 3, (B) a cross-sectional view of the liquid crystal display device 10 taken along line A-A indicated by arrows in (A), and (C) a cross-sectional view of the liquid crystal display device 10 taken along line B-B indicated by arrows in (A). While the liquid crystal display device 10 in FIG. 4(A) is shown, for simplification, with the stabilizing capacitors 61 but with no other capacitors mounted on the projection 20a, the bypass capacitors and the boosting capacitors are also mounted. For simplicity of explanation, while only the stabilizing capacitors 61 will be described below and any descriptions of the bypass capacitors and the boosting capacitors will be omitted, the description of the stabilizing capacitors 61 is similarly applied to them.

As shown in FIG. 4(B), face-down bonding of the LSI chip 40 is performed using an ACF 81, so that bump electrodes 40a formed on the chip are connected to one terminal of an FPC trace 73 formed on the projection 20a and to a trace layer 23 extending toward the display portion 30. Also, each trace layers 74 formed on the insulating film 51 of the FPC board 50 is connected to the other terminal of the FPC trace 73 using an ACF 82. In this manner, the trace layers 74 of the FPC board 50 are connected to input terminals of the LSI chip 40 via the FPC traces 73, and therefore external signals to the trace layers 74 of the FPC board 50, such as video signals, clock signals and reference voltage, are provided to their corresponding input terminals of the LSI chip 40.

Also, as shown in FIG. 4(C), each of the stabilizing capacitors 61 is connected at one terminal via an ACF 83 to a capacitor trace 71 formed on the projection 20a and at the other terminal to the grounding conductor 72. Note that in the present embodiment, traces 71 connected to the stabilizing capacitors 61, the bypass capacitors 62 and the boosting capacitors 63 are referred to as “capacitor traces 71”.

The ACFs 81 to 83 used for such connections are molded in the form of films by mixing fine conducting particles with thermosetting resin such as epoxy-based resin. A case where the stabilizing capacitor 61 and the capacitor trace 71 are connected using the ACF 83 will be described. The ACF 83 is supplied onto the capacitor trace 71, the stabilizing capacitor 61 is aligned such that one terminal thereof is positioned above one terminal of the capacitor trace 71 and the other terminal is positioned above the grounding conductor 72, and thereafter the stabilizing capacitor 61 is temporarily pressure-bonded onto the surface of the ACF 83 using a chip mounter.

Next, the ACF 83 is heated to a predetermined temperature while the upper surface of the stabilizing capacitor 61 is pressed with a predetermined force for a predetermined period of time, so that no pressure is applied to any ACFs other than the ACF 83 between the terminal of the stabilizing capacitor 61 and either the capacitor trace 71 or the grounding conductor 72. Consequently, conducting particles dispersed in the ACF 83 are overlapped in contact with one another, thereby forming a conducting path. At this time, any conducting particles in the ACF 83 that have no pressure applied thereto do not form a conducting path, so that in-plane insulation properties are maintained. If the ACF 83 is heated with pressure applied thereto, thermosetting resin included in the ACF 83 is cured, and therefore the conducting path formed in the ACF 83 remains as is after pressure is removed. Note that instead of using the ACF 83, anisotropic conductive paste may be used which is not in the form of a film unlike the ACF 83 and is obtained by mixing conducting particles in paste-like thermosetting resin. Both the anisotropic conductive film and the anisotropic conductive paste are referred to herein as anisotropic conductive adhesives.

Also, even when the stabilizing capacitors 61, the bypass capacitors 62, and the boosting capacitors 63 (to be referred to as the “capacitors 61 to 63” hereinafter in some cases), which are mounted on the projection 20a, differ in terms of their height, approximately equal pressure can be applied to the capacitors 61 to 63 simultaneously by pressing their top surfaces using an elastic material such as rubber (see, for example, Japanese Laid-Open Patent Publication No. 2000-68633). Consequently, the capacitors 61 to 63 of different height can be simultaneously connected to the capacitor traces 71 on the projection 20a with a single operation, making it possible to simplify the process of manufacturing the liquid crystal display device 10.

Furthermore, the capacitor traces 71, the grounding conductor 72, and the FPC traces 73 are formed using tantalum or aluminum as used in formation of the display portion 30, and therefore the traces 71 to 73 can be formed together with the traces in the display portion 30 during the same process. Thus, the process of manufacturing the liquid crystal display device 10 can be further simplified.

<2.2 Positional Relationship Between The Capacitors And The LSI Chip>

Next, the stabilizing capacitors 61, the bypass capacitors 62 and the boosting capacitors 63 will be described regarding their positional relationship with the LSI chip 40. As described in the “Basic Study” section, to reduce the resistance of the capacitor traces 71 formed on the projection 20a of the glass substrate 20, the length of the traces needs to be shortened even if by only 1 mm.

To this end, as shown in FIG. 3, one terminal of each of the stabilizing capacitors 61 and the bypass capacitors 62 is positioned close to its corresponding terminal of the LSI chip 40, and both terminals of each of the boosting capacitors 63 are positioned close to their corresponding terminals of the LSI chip 40 and are connected to the LSI chip 40 via their respective capacitor traces 71. The bump electrodes of the LSI chip 40 that are connected to the terminals of the capacitors 61 to 63 are provided along the long side of the LSI chip 40. Accordingly, the width of the capacitor traces 71 for connecting the terminals of the capacitors 61 to 63 to the bump electrodes 40a of the LSI chip 40 is determined by the length of the long side of the LSI chip 40 and the number of capacitors 61 to 63 to be mounted.

On the other hand, the length of the capacitor traces 71 is determined such that the trace resistance is set at an allowable value or lower. For example, when tantalum is used as a trace material, the allowable resistance value of the capacitor traces 71 is 50Ω or less, and the traces 71 are 50 μm in width and 0.3 μm in thickness, the length of the capacitor traces 71 must be 6 mm or less. Therefore, to adjust the capacitor traces 71 to be 6 mm or shorter, the stabilizing capacitors 61, the bypass capacitors 62 and the boosting capacitors 63 are understandably mounted in an array along the long side on the input side of the LSI chip 40.

Note that in FIG. 3, bump electrodes 40a are also disposed on the short side of the LSI chip 40 for the purpose of connecting with some stabilizing capacitors 61. By mounting some stabilizing capacitors 61 in an array along the short side of the LSI chip 40, some capacitor traces 71 on the short side can have their length set at an allowable resistance value or less. In this manner, when the bump electrodes 40a for connecting with the capacitors 61 to 63 are disposed on the short side of the LSI chip 40, the capacitors 61 to 63 can be mounted not only along the long side of the LSI chip 40 but also along the short side.

When aluminum is used as a trace material, as shown in the “Basic Study” section, the sheet resistance of aluminum is substantially low, such as about ⅕ of that of tantalum. Therefore, in the case where the tolerance of the trace resistance and the thickness of the capacitor traces 71 composed of aluminum are the same as those when the capacitor traces 71 are composed of tantalum, the aluminum capacitor traces 71 have about five times the length of the tantalum capacitor traces 71, i.e., the allowable length is up to about 30 mm. Therefore, where the stabilizing capacitors 61, the bypass capacitors 62 and the boosting capacitors 63 are mounted, the degree of freedom in arranging the capacitors 61 to 63 is higher in the case where the aluminum capacitor traces 71 are used than in the case where the tantalum capacitor traces 71 are used.

Next, the LSI chip 40 will be described regarding a preferred terminal arrangement (bump electrode 40a arrangement) on the input side. Arranged on the input side of the LSI chip 40 are, for example, video signal input terminals, clock signal input terminals, input terminals for reference potential and so on, and terminals connected to the capacitors 61 to 63. The FPC board 50 can be further narrowed by designing the LSI chip 40 such that the above terminals, i.e., the video signal input terminals, the clock signal input terminals, and the terminals for reference potential, are arranged in series without any intervening terminals connected to the capacitors 61 to 63.

Also, conventionally, the LSI chip 40 has a power-supply voltage input terminal (power input terminal) provided at its end. Therefore, a trace for providing the power-supply voltage is disposed at the edge of the FPC board 50, and when the FPC board 50 is connected to the projection 20a, the trace on the FPC board 50 for providing power-supply voltage is connected to the power input terminal of the LSI chip 40 via the power line formed on the projection 20a. In this case, the capacitors 61 to 63 are mounted along the long side of the LSI chip 40, making some available space on the projection 20a. Therefore, using the available space, a wide power line is formed to prevent any drop in the power-supply voltage.

However, the LSI chip 40 can be designed such that the power input terminal is positioned close to the video signal terminals and the like on the input side of the LSI chip 40 without any intervening terminals connected to the capacitors 61 to 63. In this case, in addition to video signals and so on, the power-supply voltage can be provided from the FPC board 50 to the LSI chip 40 via the FPC trace 73. Thus, it is possible to eliminate the need to form the power line on the projection 20a, thereby reducing manufacturing cost of the liquid crystal display device 10.

<2.3 Effect>

According to the above embodiment, the FPC board 50 can be narrowed without bending the FPC board 50 connected to the glass substrate 20 and fixing the bent FPC board 50 with tape. Accordingly, it is possible to achieve size reduction of the electronic device including the liquid crystal display device 10 with the FPC board 50 packaged therein. Also, since the need for the processes of bending the FPC board 50 and fixing the FPC board 50 with tape is eliminated, it is possible to achieve reduction in packaging cost as well as reduction in manufacturing cost, including cost of material and processing of the FPC board 50. Furthermore, the stabilizing capacitors 61, the bypass capacitors 62 and the boosting capacitors 63 are disposed close to the LSI chip 40, resulting in shortened capacitor traces 71. Thus, the LSI chip 40 becomes less susceptible to EMI, and also it is possible to prevent any drop in the power-supply voltage due to the trace resistance of the capacitor traces 71.

<3. Second Embodiment>

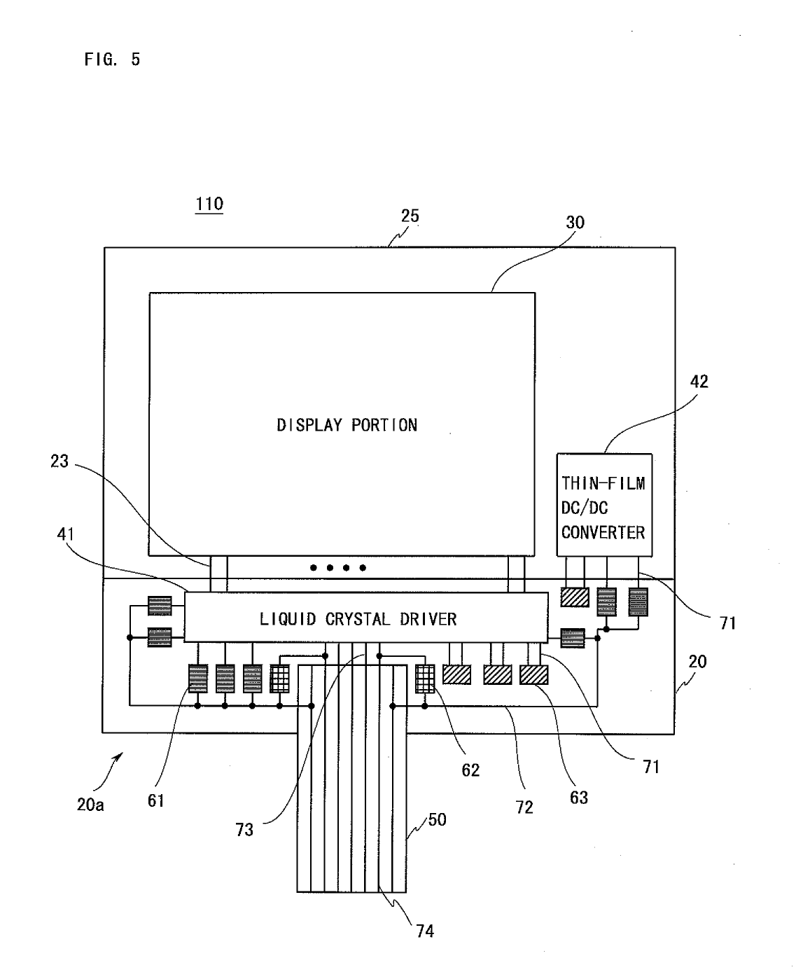

FIG. 5 is a schematic plan view illustrating the configuration of a liquid crystal display device 110 according to a second embodiment of the present invention. Elements of the liquid crystal display device 110 shown in FIG. 5 that are the same as or correspond to those of the liquid crystal display device 10 according to the first embodiment will be denoted by the same reference characters, and descriptions will be given mainly focusing on differences from the liquid crystal display device 10.

In the liquid crystal display device 10, the DC/DC converter is included in the LSI chip 40 along with the gate driver and the source driver. However, in the liquid crystal display device 110 according to the present embodiment, the DC/DC converter 42, along with the display portion 30, is formed using a thin film of continuous grain silicon (CG silicon), amorphous silicon, polycrystalline silicon or the like, in an area of the glass substrate 20 that is covered by the glass substrate 25 around the display portion 30. Accordingly, the DC/DC converter 42 is referred to herein as the “thin-film DC/DC converter 42” or the “thin-film power generation circuit”.

Also, the DC/DC converter included in the LSI chip 40 is independently provided as the thin-film DC/DC converter 42, so that a liquid crystal driver chip 41 having the gate driver and the source driver provided therein is mounted on the projection 20a in place of the LSI chip 40.

The stabilizing capacitors 61 and the boosting capacitors 63, which are connected to the thin-film DC/DC converter 42, are mounted on the projection 20a, and connected to the thin-film DC/DC converter 42 via their respective tantalum or aluminum capacitor traces 71 formed on the projection 20a. In this case, to allow the thin-film DC/DC converter 42 to operate normally, it is necessary to shorten the capacitor traces 71 such that the trace resistance thereof becomes smaller than a predetermined value, as described in the “Basic Study” section. Therefore, to shorten the capacitor traces 71 formed on the projection 20a as much as possible, the stabilizing capacitors 61 and the boosting capacitors 63, which are connected to the thin-film DC/DC converter 42, are mounted in an array on the projection 20a adjacent to the edge of the glass substrate 25.

Also, the stabilizing capacitors 61, the bypass capacitors 62 and the boosting capacitors 63, which are connected to input-side terminals of the liquid crystal driver chip 41, are mounted adjacent to the long side, or both the long side and the short, of the chip along which the input-side terminals of the liquid crystal driver chip 41 are positioned, as in the case of the liquid crystal display device 10 according to the first embodiment.

Note that the effect achieved by the liquid crystal display device 110 according to the present embodiment is the same as that achieved by the liquid crystal display device 10 according to the first embodiment, and therefore any description thereof will be omitted.

<4. Third Embodiment>

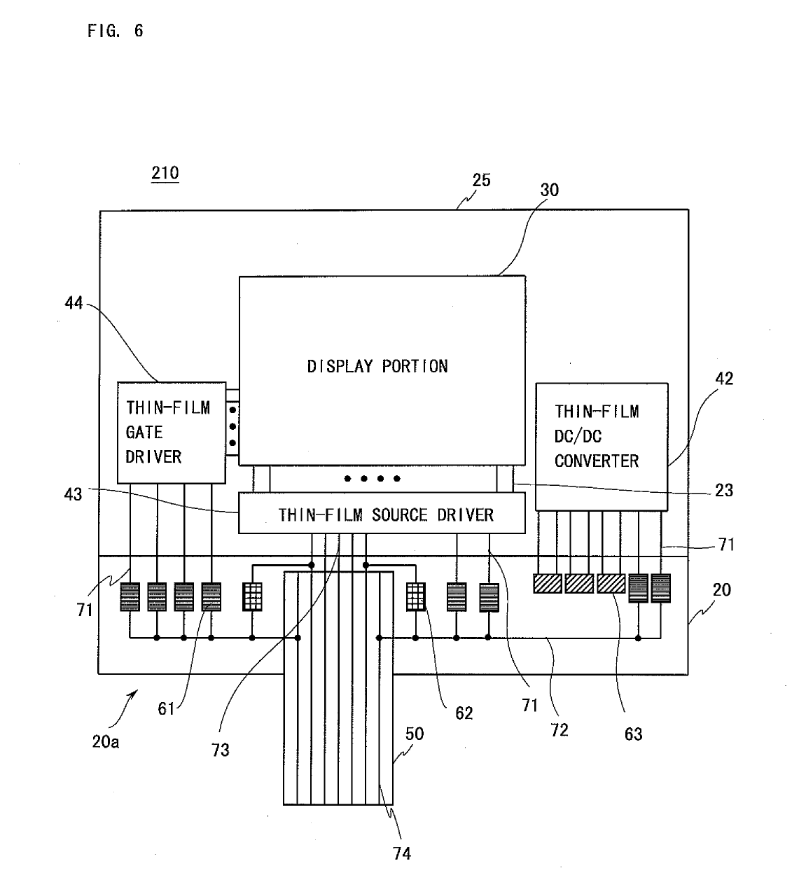

FIG. 6 is a schematic plan view illustrating the configuration of a liquid crystal display device 210 according to the third embodiment of the present invention. Elements of the liquid crystal display device 210 shown in FIG. 6 that are the same as or correspond to those of the liquid crystal display device 10 according to the first embodiment will be denoted by the same reference characters, and descriptions will be given mainly focusing on differences from the liquid crystal display device 10.

In the liquid crystal display device 10, the gate driver, the source driver and the DC/DC converter are all included in the LSI chip 40. However, in the liquid crystal display device 210 according to the present embodiment, the DC/DC converter, the source driver and the gate driver are all formed using a thin film of continuous grain silicon (CG silicon), amorphous silicon, polycrystalline silicon or the like, in an area of the glass substrate 20 that is covered by the glass substrate 25 and is adjacent to the display portion 30. Accordingly, herein, the source driver and the gate driver are referred to as the “thin-film source driver 43” and the thin-film gate driver 44, respectively, and both the thin-film source driver 43 and the thin-film gate driver 44 may be referred to as the thin-film driver circuits. Also, the liquid crystal display device 210 has the thin-film DC/DC converter 42, the thin-film source driver 43 and the thin-film gate driver 44 formed thereon, and therefore no LSI chip having the same functions as them is mounted on the projection 20a.

Accordingly, the stabilizing capacitors 61, the bypass capacitors 62 and the boosting capacitors 63 are all mounted on the projection 20a and connected to the thin-film DC/DC converter 42, the thin-film source driver 43 or the thin-film gate driver 44 via the capacitor traces 71 made of tantalum or aluminum.

To allow the thin-film DC/DC converter 42, the thin-film source driver 43 and the thin-film gate driver 44 to operate normally, it is necessary to shorten the capacitor traces 71 such that the trace resistance thereof becomes smaller than a predetermined value, as described in the “Basic Study” section. Therefore, to shorten the capacitor traces 71 formed on the projection 20a as much as possible, the stabilizing capacitors 61, the bypass capacitors 62 and the boosting capacitors 63 are all mounted in an array on the projection 20a adjacent to the edge of the glass substrate 25.

Note that the effect achieved by the liquid crystal display device 210 according to the present embodiment is the same as that achieved by the liquid crystal display device 10 according to the first embodiment, and therefore any description thereof will be omitted.

<5. Variants>

Common variants on the first to third embodiments will be described. Note that, for convenience of explanation, the following variants will be described as variants on the first embodiment, but they are similarly applicable to the other embodiments.

<5.1 First Variant>

In the liquid crystal display device 10 according to the first embodiment, the FPC board 50, which is a flexible circuit board using a thin elastic insulating material as the insulating film 51, is connected to the projection 20a using the ACF 84. However, a rigid circuit board 53, which uses a less flexible substrate, is used in place of the FPC board 50. Accordingly, both the flexible circuit board, such as the FPC board 50, and the rigid circuit board 53 are referred to herein as circuit boards.

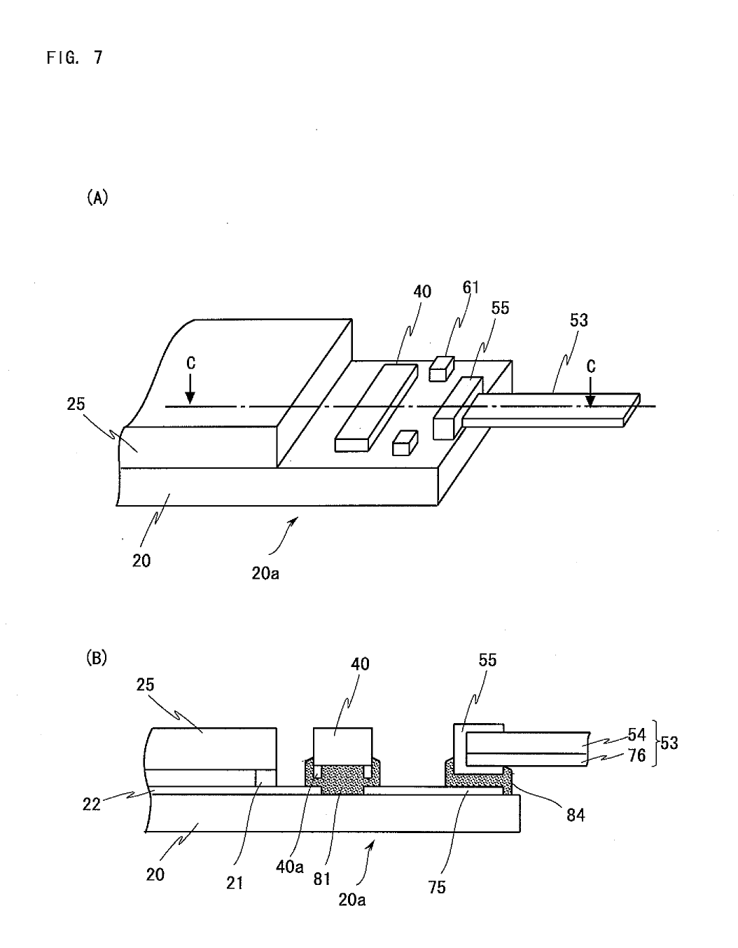

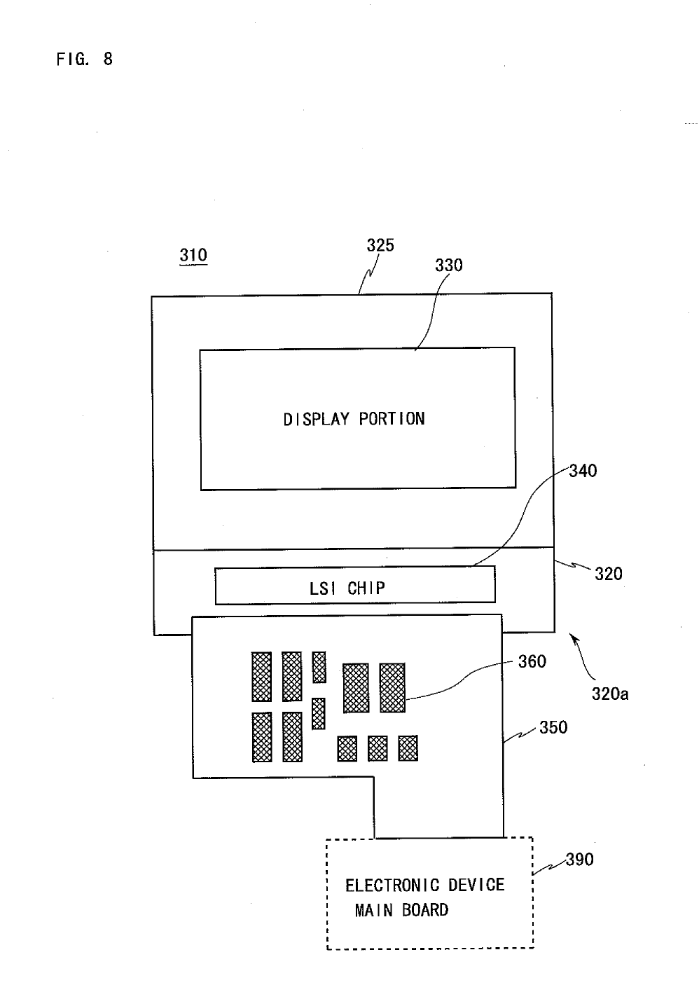

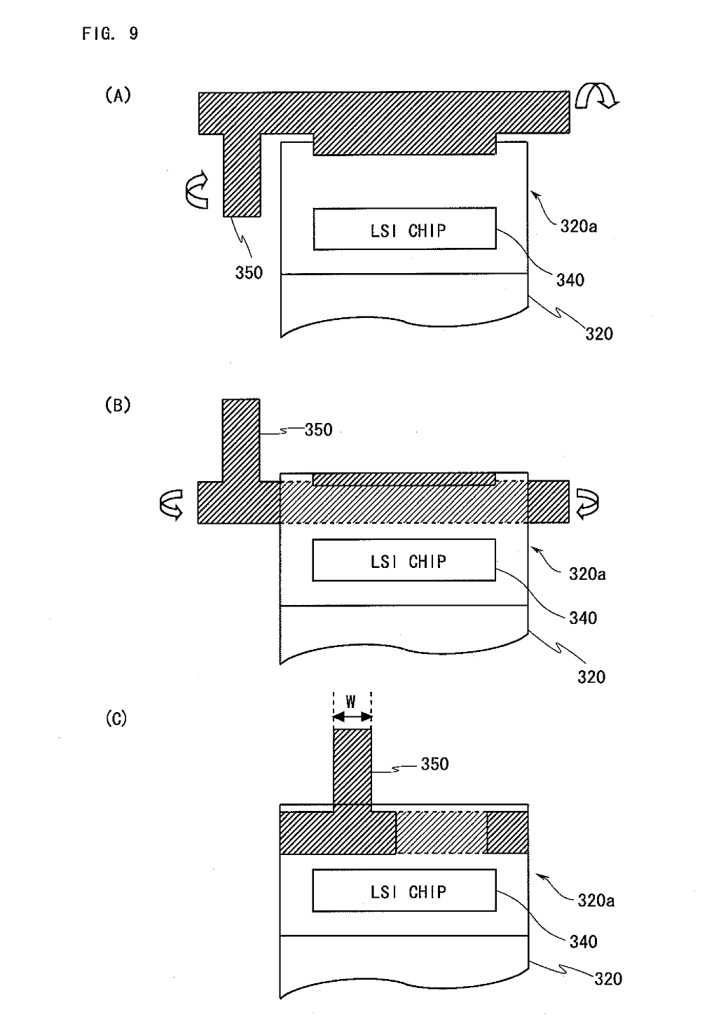

FIG. 7 provides (A) a perspective view of a liquid crystal display device having the rigid circuit board 53 attached thereto and (B) a cross-sectional view of the liquid crystal display device taken along line C-C indicated by arrows in (A). In FIGS. 7 (A) and (B), elements that are the same as or correspond to those of the liquid crystal display device 10 according to the first embodiment are denoted by the same reference characters, and descriptions will be given mainly focusing on differences from the liquid crystal display device 10.

As shown in FIG. 7(B), a B-to-B (Board-to-Board) connector 55 is attached to the projection 20a of the glass substrate 20 by the ACF 84. An output side terminal of the B-to-B connector 55 is connected to connector traces 75 connected to input-side terminals of the LSI chip 40. Also, the rigid circuit board 53 is inserted into the input side of the B-to-B connector 55. Consequently, externally provided video signals, clock signals, reference voltage and so on are transferred to the LSI chip 40 via trace layers 76 formed on the rigid board 54 and the connector traces 75.

Unlike the FPC board 50, the rigid circuit board 53 lacks flexibility and therefore is not suitable for electronic devices that need size reduction. However, the ACF is not required for inserting the rigid circuit board 53 into the B to B connector 55, and therefore it is possible to attach/remove the rigid circuit board 53 to/from the B to B connector 55 as many times as needed.

<5.2 Second Variant>

As for the liquid crystal display device 10 according to the first embodiment, the discrete electronic components to be mounted on the projection 20a have been described as being chip capacitors. However, the discrete electronic components to be mounted on the projection 20a are not limited to chip capacitors and may be other passive components such as chip resistors and chip coils or active components such as light-emitting diodes (LEDs) and other diodes. Light-emitting diodes, when mounted on the liquid crystal display device, are used as backlight sources, for example. In this manner, the discrete electronic components herein include not only passive components but also active components.

Depending on the discrete electronic components, it is possible to allow the LSI chip 40 to operate normally by shortening the traces and thereby preventing any delay in the rise and fall of signals. Also, herein, traces connecting the discrete electronic components and the LSI chip 40 (a driver circuit to be described later), such as the capacitor traces 71, are referred to as component traces.

The LSI chip 40 mounted on the liquid crystal display device 10 is a bare chip bonded face-down to the projection 20a. In this case, it is possible to reduce the mounting area of the LSI chip 40 and furthermore the areas of the glass substrates 20. However, an LSI device having the LSI chip 40 encapsulated in a surface-mount package may be mounted on any of the glass substrates 20. Herein, the LSI device, the LSI chip, the thin-film driver circuit and the thin-film power generation circuit are all referred to as the driver circuits.

Note that the chip capacitors are not limited to the ceramic chip capacitors and may be, for example, tantalum or niobium oxide chip capacitors. Also, the liquid crystal display device 10 has been described as using the glass substrates 20 and 25, but insulating substrates such as transparent plastic substrates may be used.

<5.3 Third Variant>

The first embodiment has been described with respect to the liquid crystal display device 10 to be provided in a cell phone or suchlike, but the liquid crystal display device is not restrictive and the present invention is applicable to various display devices such as organic or inorganic EL (electro luminescence) displays, plasma display panels (PDPs), vacuum fluorescent displays and electronic paper. Accordingly, the liquid crystal display devices 10, 110 and 210 according to the first to third embodiments and the display devices as mentioned above are all referred to herein as “display devices”.

### INDUSTRIAL APPLICABILITY

The display device of the present invention can be reduced in size by narrowing the gap between printed circuit boards having electronic components mounted thereon, and therefore is applicable as a display device for a compact electronic device such as a portable terminal.

### DESCRIPTION OF THE REFERENCE CHARACTERS

10, 110, 210 liquid crystal display device

20, 25 glass substrate

20a projection

30 display portion

40 LSI chip

40a bump electrode

41 liquid crystal driver

42 thin-film DC/DC converter

43 thin-film source driver

44 thin-film gate driver

50 FPC board

53 rigid circuit board

55 B-to-B connector

61 stabilizing capacitor

62 bypass capacitor

63 boosting capacitor

71 capacitor trace

72 grounding conductor

73 FPC trace

74, 76 trace layer of FPC board

75 connector trace

81 to 84 ACF (anisotropic conductive film)

1. A display device for displaying video based on an externally provided video signal, comprising:
a first insulating substrate;
a display portion formed on the first insulating substrate to display video;
a driver circuit disposed on the first insulating substrate to drive the display portion based on the video signal;
discrete electronic components disposed on the first insulating substrate and required for operating the driver circuit;
component traces formed on the first insulating substrate to connect the driver circuit and the discrete electronic components; and
a circuit board having trace layers for providing externally provided signals and reference potential to the driver circuit and firmly attached to the first insulating substrate with the trace layers being connected to input traces formed on the first insulating substrate, wherein,
the discrete electronic components are disposed adjacent to the driver circuit and connected by the component traces to terminals of the driver circuit that correspond to the discrete electronic components.

2. The display device according to claim 1, wherein the discrete electronic components are connected to the component traces by anisotropic conductive adhesives.

3. The display device according to claim 1, wherein,
the first insulating substrate has a projection,
the driver circuit is a first driver circuit formed on the projection, including driver circuit to drive the display portion and a power generation circuit for providing a required voltage to the display portion, and
the discrete electronic components are disposed on the projection so as to be at least adjacent to the long side of the first driver circuit and connected to the first driver circuit by the component traces.

4. The display device according to claim 3, wherein,
the first driver circuit is a first integrated circuit chip having bump electrodes formed on its surface, and
the discrete electronic components are connected to the first integrated circuit chip by anisotropic conductive adhesives provided between the component traces and the bump electrodes.

5. The display device according to claim 1, further comprising a second insulating substrate disposed so as to be opposed to the first insulating substrate at a predetermined distance, wherein,
the first insulating substrate has a projection,
the driver circuit includes a second driver circuit for driving the display portion and a thin-film power generation circuit for providing a required voltage to the display portion, the second driver circuit being disposed on the first insulating substrate, the thin-film power generation circuit being formed together with the display portion on the first insulating substrate opposed to the second insulating substrate,
the discrete electronic components include first discrete electronic components required for operating the second driver circuit and second discrete electronic components required for operating the thin-film power generation circuit,
the component traces include first component traces connecting the second driver circuit to the first discrete electronic components and second component traces connecting the thin-film power generation circuit to the second discrete electronic components,
the first discrete electronic components are disposed on the projection so as to be at least adjacent to the long side of the second driver circuit and connected by the first component traces to the second driver circuit, and
the second discrete electronic components are disposed on the projection adjacent to an edge of the second insulating substrate and connected by the second component traces to the thin-film power generation circuit.

6. The display device according to claim 5, wherein,
the second driver circuit is a second integrated circuit chip having bump electrodes formed on its surface, and
the first discrete electronic components are connected to the second integrated circuit chip by anisotropic conductive adhesives provided between the first component traces and the bump electrodes.

7. The display device according to claim 1, further comprising a second insulating substrate disposed so as to be opposed to the first insulating substrate at a predetermined distance, wherein,
the first insulating substrate has a projection,
the driver circuit includes a thin-film driver circuit for driving the display portion and a thin-film power generation circuit for providing a required voltage to the display portion, the thin-film driver circuit and the thin-film power generation circuit being formed together with the display portion on the first insulating substrate opposed to the second insulating substrate,
the discrete electronic components include first discrete electronic components required for operating the thin-film driver circuit and second discrete electronic components required for operating the thin-film power generation circuit,
the component traces include first component traces connecting the second driver circuit to the first discrete electronic components and second component traces connecting the thin-film power generation circuit to the second discrete electronic components,
the first discrete electronic components are disposed on the projection adjacent to an edge of the second insulating substrate and connected by the first component traces to the thin-film driver circuit, and
the second discrete electronic components are disposed on the projection adjacent to the edge of the second insulating substrate and connected by the second component traces to the thin-film power generation circuit.

8. The display device according to claim 1, wherein the discrete electronic components are disposed close to the driver circuit such that trace resistance of the component traces has a resistance value not affecting the operation of the driver circuit.

9. The display device according to claim 8, wherein the component traces are made of the same material as traces within the display portion.

10. The display device according to claim 1, wherein the discrete electronic components at least include chip capacitors, chip resistors, chip coils, light-emitting diodes or other diodes.

11. The display device according to claim 10, further comprising a grounding conductor formed on the first insulating substrate to provide reference potential, wherein,
the chip capacitors include:
boosting capacitors for generating voltage to be provided at a predetermined value to the display portion in concert with the driver circuit, the boosting capacitors having terminals connected to corresponding terminals of the driver circuit;
stabilizing capacitors for removing noise superimposed on voltage generated within the driver circuit, the stabilizing capacitors each being connected at one terminal to a corresponding terminal of the driver circuit and at the other to the grounding conductor; and
bypass capacitors for removing noise superimposed on signals externally provided via the trace layers of the circuit board, the bypass capacitors each being connected at one terminal to a corresponding terminal of the driver circuit and at the other to the grounding conductor.

12. The display device according to claim 1, wherein,
the circuit board is a flexible circuit board, and
the trace layers of the flexible circuit board are connected to the input traces formed on the first insulating substrate by anisotropic conductive adhesives.

13. The display device according to claim 1, further comprising a connector connected to the input traces formed on the first insulating substrate by an anisotropic conductive adhesive, wherein,
the circuit board is a stiff, rigid circuit board, and
the trace layers formed on the rigid circuit board are connected to the input traces by the connector.

14. The display device according to claim 1, wherein the driver circuit has provided thereto a series of input terminals corresponding to the trace layers formed on the circuit board.

15. The display device according to claim 1, further comprising a liquid crystal enclosed in the display portion, wherein,
the driver circuit drives the liquid crystal based on the video signal externally provided via the circuit board, thereby displaying video on the display portion.
